(19) United States
(12) Patent Application Publication
(10) Pub. No.: US 2024/0413476 A1
(43) Pub. Date: Dec. 12, 2024

(54) ASSEMBLED MANIFOLD FOR THERMAL RUNAWAY VENT GAS TRANSPORT IN BATTERY SYSTEMS

(71) Applicant: GM GLOBAL TECHNOLOGY OPERATIONS LLC, Detroit, MI (US)

(72) Inventors: Anthony Michael Coppola, Rochester Hills, MI (US); William Thomas Kucinski, Windsor (CA); Ryan Patrick Hickey, Austin, TX (US); Mohammad Hamza Kirmani, Troy, MI (US); Michael Victor Pyrtko, Ferndale, MI (US)

(21) Appl. No.: 18/331,673

(22) Filed: Jun. 8, 2023

(51) Int. Cl. H01M 50/367; B60R 16/033; H01M 10/48; H01M 50/249; H01M 50/262

(52) U.S. Cl. CPC H01M 50/367; B60R 16/033; H01M 10/482; H01M 50/249; H01M 50/262

(57) ABSTRACT

A battery pack for a vehicle includes a housing including at least one pack vent between an interior and an exterior of the housing; a plurality of battery cells disposed within the housing; and a vent system includes a closed channel network under the cells in connection with a vent of the plurality of battery cells and the at least one pack vent; and a manifold mounted on the closed channel network, a portion of the manifold mounted on the housing including a connector installed from external to the housing that connects the manifold to the closed channel network.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Ventilating the battery cells of a battery pack for an electric vehicle is known in the art. The vent system must remain open for gas to traverse during a thermal event so that the gas is able to reach the pack's vent port. The rest of the pack is commonly filled with potting resin (foamed or non-foamed) for electrical isolation, structural performance and thermal insulation. Controlling the position of the potting is challenging. The variability of foam expansion makes the baseline system incompatible with foam potting.

The present disclosure relates to an assembled manifold for thermal runaway vent gas transport in battery systems.

### SUMMARY

The main objective of the present disclosure is to create a closed volume for the thermal runaway gas vent system. This closed volume cannot be blocked by potting during manufacturing.

According to an aspect of the present disclosure, a battery pack for a vehicle includes a housing including at least one pack vent between an interior and an exterior of the housing. A plurality of battery cells are disposed within the housing. A vent system includes a closed channel network under the cells in connection with a vent of the plurality of battery cells and the at least one pack vent. A manifold is mounted on the closed channel network, a portion of the manifold mounted on the housing includes a connector installed from external to the housing that connects the manifold to the closed channel network.

According to another aspect, the pack mounted portion of the manifold includes a sealing material engaging the connector.

According to another aspect, the sealing material includes a rubber foam.

According to another aspect, the manifold connects channels coming from at least two modules to a single pack vent.

According to another aspect, a potting material fills all cavities external to the vent system.

According to another aspect, the potting material includes one of a blown foam, a syntactic foam, and a non-foamed polymeric resin.

According to another aspect, the vent system is sealed to prevent potting from entering the vent system during manufacture of the pack.

According to another aspect, the closed channel network includes a cell channel array.

According to another aspect, the cell channel array includes at least two pieces per battery module.

According to another aspect, a gap between the at least two pieces is less than 3 mm.

According to another aspect, the closed channel network includes cell tray and vent tray stacks sealed with other cell tray and vent tray stacks to create a sealed vent channel battery module.

According to another aspect, the seal could be achieved using at least one of mechanical joining, fusion bonding, welding, solvent bonding and adhesive bonding.

According to another aspect, the ends of the cell trays facing another cell tray contain molded features to enable one of snap and press fitting.

According to another aspect, one of the vent tray and the cell tray include a plurality of ribs defining channels therebetween.

According to another aspect, a thermal runaway sensor in communication with the channel network.

According to another aspect, the thermal runaway sensor is mounted in the manifold.

According to a further aspect, a battery pack for a vehicle includes a housing including at least one pack vent between an interior and an exterior of the housing. A plurality of battery cells are disposed within the housing. A vent system includes a closed channel network under the cells in connection with a vent of the plurality of battery cells and the at least one pack vent. The closed channel network includes cell tray and vent tray stacks sealed with other cell tray and vent tray stacks to create a sealed vent channel battery module. A manifold is mounted on the closed channel network and includes a connector installed from external to the housing that connects the manifold to a cell vent manifold mounted to a cell tray of the closed channel network.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a partial cross-sectional view of a battery pack having a vent system according to the principles of the present disclosure;

FIG. 2 is a perspective view of a battery vent system with a channel array connecting each battery cell to a pack vent;

FIG. 3 is a detailed view of the connection between the channel array and the pack vent manifold;

FIG. 4 is a perspective cut-away view of the connection between the channel array and the pack vent manifold;

FIG. 5 is a cross-sectional view of the cell tray of the channel array;

FIG. 6 is a cross sectional view of the interface between adjacent cell trays;

FIG. 7 is an exemplary schematic view of the channel array system; and

FIG. 8 is a cross-sectional view of the pack vent manifold.

In the drawings, reference numbers may be reused to identify similar and/or identical elements.

### DETAILED DESCRIPTION

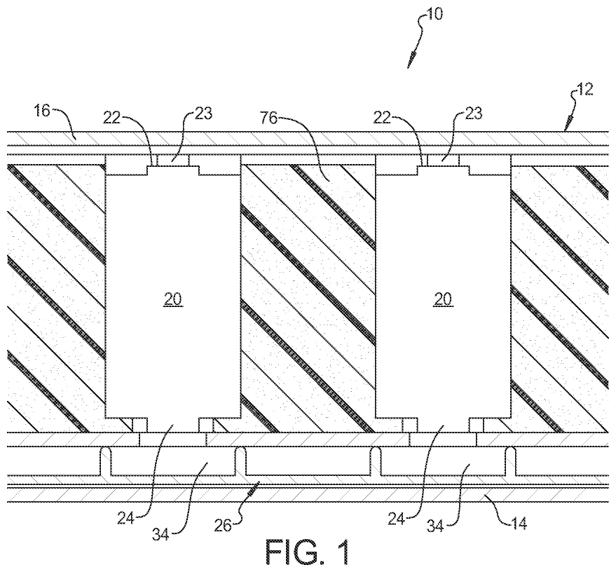

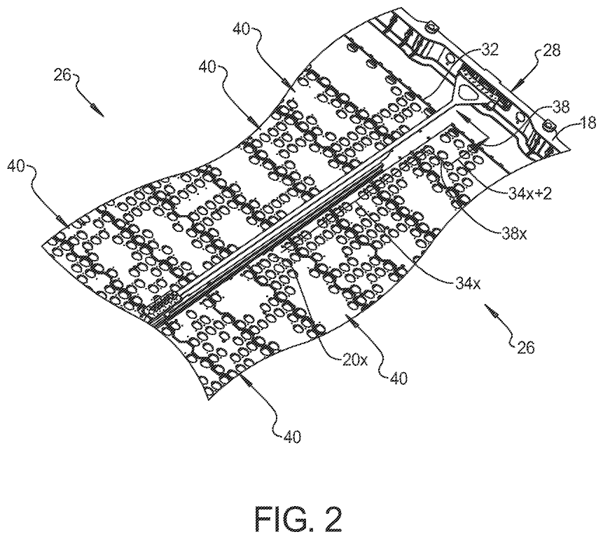

With reference to FIG. 1, a battery pack 10 is schematically shown including a housing 12 having a bottom shear plate 14, a top shear plate 16 and a sidewall enclosure 18 (see FIG. 2). A plurality of battery cells 20 are disposed within the housing 12. The battery cells 20 each include electric terminals 22 for connection to a bus bar or other system 23 for electrical connection. The battery cells 20 each include a vent 24 in communication with a vent channel array 26.

As shown in FIG. 2, the channel array 26 connects the vent 24 of each of the battery cells 20 to a pack vent 28 provided in the housing 12 via an outlet port 32 of the channel array 26 that is connected with the pack vent 28. The channel array 26 includes a plurality of channels 34 separated by a series of ribs 36 that include openings 38 for communicating the vent 24 of each battery cell 20 with the outlet port 32 of the channel array 26.

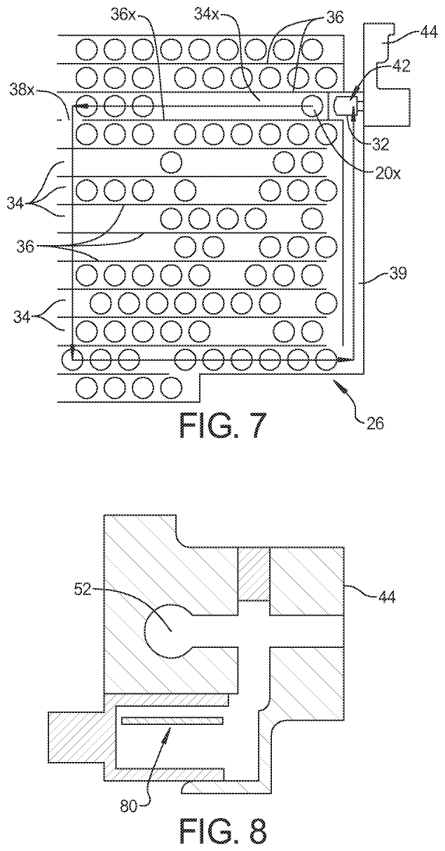

By way of example, as shown in FIG. 7, the vent from the battery cell 20x communicates through a channel 34x, through opening 38x in rib 36x and to channel 34x+9 and along a manifold path 39 to the outlet port 32 as indicated by the direction arrows. As shown in FIG. 7, the ribs 36 include openings 38 to allow the vent 24 of each battery cell 20 to communicate through and across the channels 34 to the outlet port 32. The channels 34 and the openings 38 can be provided with numerous alternative arrangements for communicating gasses from the battery cells 20 to the outlet port 32. The system easily enables a longer gas travel path to enable the gas temperature to be reduced prior to the gas exiting the battery pack 10.

With reference to FIG. 2, the channel array 26 is shown being made up of interlocking channel panels 40 that interlock with adjacent channel panels 40 and communicate each battery cell to the outlet ports 32.

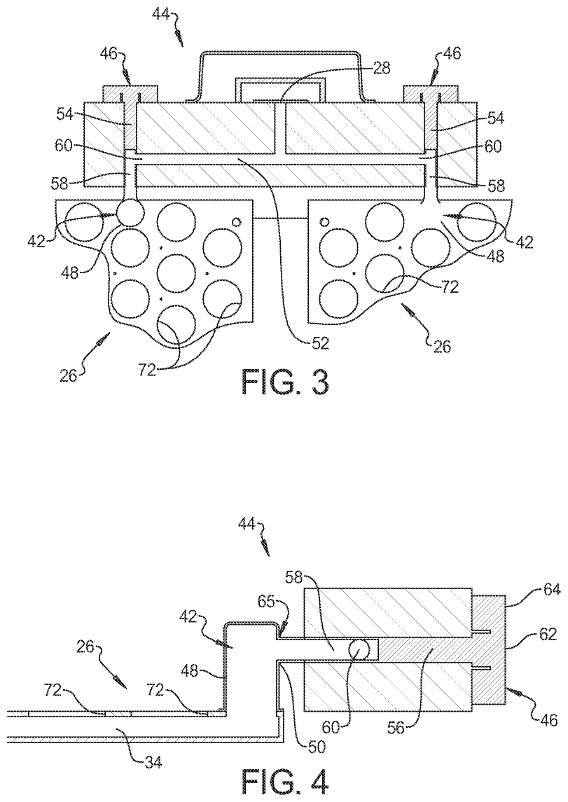

With reference to FIGS. 3 and 4, a cell vent manifold 42 to pack vent manifold 44 connection is made by a connector 46 inserted from an exterior of the batter pack 10. The cell vent manifold 42 includes a cup-shaped body 48 sealingly connected to the channel panel 40 above the outlet port 32. The cell vent manifold 42 include an aperture 50 in a side thereof. The pack vent manifold 44 supports the pack vent 28 and includes an internal passageway 52 that extends from the pack vent 28 to a pair of apertures 54 that receive the connectors 46. The connectors 46 include an elongated rod 56 having a passage 58 therein that communicates with an end of the elongated rod and a side aperture 60 that aligns with the internal passageway 52 of the pack vent manifold when the connectors 46 are inserted in the apertures 54. The connectors 46 can include a head portion 62 that can be connected to the sidewall 18 or pack vent manifold 44 using fasteners 64 or other fastening techniques. The connector 46 utilizes rubber foam gaskets 65 surrounding the aperture 50 in the cell vent manifold 42 that seal over a large area to ensure the potting cannot enter the vent system during manufacturing.

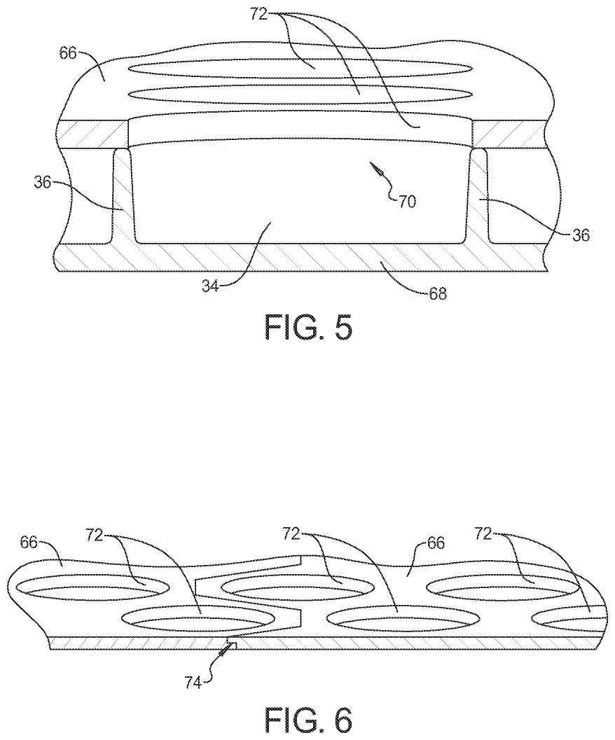

With reference to FIG. 5-6, the channel array 26 is shown including battery cell engagement panels 66 and tray panels 68 that combine to define the channels 34 therebetween. The battery cell engagement panels 66 and the tray panels 68 can be formed as injection molded parts. A breakable sheet 70 may be added under the battery cell engagement panels 66 to thermally shield the rest of the cells during a thermal runaway event of the single cell. Sealant may be added to help hold the breakable sheet 70 in place. The breakable sheet 70 may be made from mica, phenolic, or another thermally resilient but brittle material that is breakable in response to a thermal event of a battery cell 20. The battery cell engagement panels 66 include apertures 72 that communicate with a vent opening of each battery cell 20. One of the battery cell engagement panels 66 and the tray panels 68 include the ribs 36 for defining the channels 34 of the channel array 26 that communicate each aperture 72 to the outlet port 32. The ribs 36 can be sealed to the opposing one of the battery cell engagement panel 66 or the tray panel 68 to provide sealed channels 34. In addition, as shown in FIG. 6, a scarf joint 74 is provided at an interface of the adjacent battery cell engagement panels 66. A gap between the scarf joint 74 is less than one half a thickness of the battery cell engagement panel 66 (generally less than 2-3 mm). The battery pack 10 is at least partially filled with potting 76, as shown in FIG. 1. The scarf joint 74 prevents the potting 76 from entering the cell channel array 26. The joint 74 may be further sealed with a sealant or tape. The seal could be achieved using at least one of mechanical joining, fusion bonding, welding, solvent bonding and adhesive bonding. The entire vent system is sealed such that the potting 76 cannot enter the system during manufacture. The potting material 76 includes one of a blown foam, a syntactic foam, and a non-foamed polymeric resin.

With the channels 34 being sealed, the foam or non-foam potting 76 can be filled to a point that it contacts the upper and lower shear plates 14, 16, enabling upper-to-lower shear plate connection through the potting 76. Once the potting is in place the vent system is sealed sufficiently to contain gas.

With reference to FIG. 8, a thermal runaway sensor 80 is shown mounted in the pack vent manifold 44 and is in communication with the gas vent path 52.

The battery pack 10 includes a closed ventilation system for transporting and reducing the temperature of discharged gas from a cell undergoing thermal runaway. The purpose of creating this closed system is to ensure potting 66 used to encapsulate the battery cells 20 does not enter the vent system during manufacturing of the battery pack 10, as well as keep hot vent gases contained and away from the remaining battery cells 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery pack for a vehicle, comprising:
a housing including at least one pack vent between an interior and an exterior of the housing;
a plurality of battery cells disposed within the housing; and
a vent system includes a closed channel network under the cells in connection with a vent of the plurality of battery cells and the at least one pack vent; and
a manifold mounted on the closed channel network, a portion of the manifold mounted on the housing including a connector installed from external to the housing that connects the manifold to the closed channel network.

2. The battery pack for a vehicle according to claim 1, wherein the pack mounted portion of the manifold includes a sealing material engaging the connector.

3. The battery pack for a vehicle according to claim 2, wherein the sealing material includes a rubber foam.

4. The battery pack for a vehicle according to claim 1, wherein the manifold connects channels coming from at least two modules to a single pack vent.

5. The battery pack for a vehicle according to claim 1, further comprising a potting material filling all cavities external to the vent system.

6. The battery pack for a vehicle according to claim 5, wherein the potting material includes one of a blown foam, a syntactic foam, and a non-foamed polymeric resin.

7. The battery pack for a vehicle according to claim 1, wherein the vent system is sufficiently sealed to prevent potting from entering the vent system during manufacture of the pack.

8. The battery pack for a vehicle according to claim 1, wherein the closed channel network includes a cell channel array.

9. The battery pack for a vehicle according to claim 8, wherein the cell channel array includes at least two pieces per battery module.

10. The battery pack for a vehicle according to claim 9, wherein a gap between the at least two pieces is less than 3 mm.

11. The battery pack for a vehicle according to claim 1, wherein the closed channel network includes cell tray and vent tray stacks sealed with other cell tray and vent tray stacks to create a sealed vent channel battery module.

12. The battery pack for a vehicle according to claim 11, wherein the seal could be achieved using at least one of mechanical joining, fusion bonding, welding, solvent bonding and adhesive bonding.

13. The battery pack for a vehicle according to claim 11, wherein the ends of the cell trays facing another cell tray contain molded features to enable one of snap and press fitting.

14. The battery pack for a vehicle according to claim 11, wherein one of the vent tray and the cell tray include a plurality of ribs defining channels therebetween.

15. The battery pack for a vehicle according to claim 1, further comprising a thermal runaway sensor in communication with the channel network.

16. The battery pack for a vehicle according to claim 15, wherein the thermal runaway sensor is mounted in the manifold.

17. A battery pack for a vehicle, comprising:
a housing including at least one pack vent between an interior and an exterior of the housing;
a plurality of battery cells disposed within the housing; and
a vent system includes a closed channel network under the cells in connection with a vent of the plurality of battery cells and the at least one pack vent, the closed channel network includes cell tray and vent tray stacks sealed with other cell tray and vent tray stacks to create a sealed vent channel battery module; and
a manifold mounted on the closed channel network, a portion of the manifold mounted on the housing including a connector installed from external to the housing that connects the manifold to a cell vent manifold mounted to a cell tray of the closed channel network.

18. The battery pack for a vehicle according to claim 17, wherein one of the connector and the cell vent manifold include a sealing material for engaging the other of the connector and the cell vent manifold.

19. The battery pack for a vehicle according to claim 18, wherein the sealing material includes a rubber foam.

20. The battery pack for a vehicle according to claim 17, further comprising a potting material filling all cavities external to the vent system.
